(19) United States
(12) Patent Application Publication
(10) Pub. No.: US 2024/0093605 A1
(43) Pub. Date: Mar. 21, 2024

(54) METHOD AND SYSTEM FOR PREDICTION AND CLASSIFICATION OF INTEGRATED VIRTUAL AND PHYSICAL SENSOR DATA

(71) Applicant: LANDMARK GRAPHICS CORPORATION, Houston, TX (US)

(72) Inventors: Travis St. George RAMSAY, Hockley, TX (US); Egidio MAROTTA, Houston, TX (US); Srinath MADASU, Houston, TX (US)

(73) Assignee: LANDMARK GRAPHICS CORPORATION, Houston, TX (US)

(21) Appl. No.: 17/766,775

(22) PCT Filed: Nov. 7, 2019
(86) PCT No.: PCT/US2019/060271

§ 371 Date: Apr. 6, 2022

(51) Int. Cl. E21B 49/08; E21B 43/16

(52) U.S. Cl. CPC E21B 49/0875; E21B 43/162; E21B 2200/22

(57) ABSTRACT

The present disclosure is related to improvements in methods for evaluating and predicting responses of virtual sensors to determine formation and fluid properties as well as classifying the predicted as plausible or outlier responses that can indicate the need for maintenance of downhole physical sensors. In one aspect, a method includes detecting a change to a system of operating a wellbore to yield a determination, the system including a virtual sensor, the virtual sensor including a physical sensor placed in the wellbore for collecting one or more physical properties inside the wellbore; and based on the determination, performing one of retraining a machine learning model for predicting an output of the virtual sensor or predicting an output of the virtual sensor using the machine learning mode, the predicted output being indicative of at least one of sub-surface formation or fluid properties inside the wellbore.

### TECHNICAL FIELD

The present technology pertains to improvements in methods for evaluating and predicting responses of virtual sensors to determine formation and fluid properties as well as classifying the predicted as plausible or outlier responses that can indicate the need for maintenance of downhole physical sensors.

### BACKGROUND

During various phases of natural resource exploration and production, it may be necessary to characterize and model a target reservoir to determine availability and potential of natural resources production in the target reservoir. Understanding petrophysical properties of the target reservoir such as gamma ray, porosity, absolute permeability, relative permeability and capillary pressure play an important role in reservoir simulation. Currently utilized methods of understanding such petrophysical and hydraulic properties include physical experiments in a laboratory setting where samples of rocks subsurface formations are extracted from a wellbore and analyzed for underlying mineralogical, pore size and pore throat distribution characteristics using CT scanners, analysis, etc. These methods must be performed ex-situ and cannot be performed in-situ with any customized physical sensors that are installed within a wellbore thus anticipating/forecasting changes in physical properties for consideration within the reservoir simulation is not directly possible with the experimental limitations of the subsurface environment. Further, forecasting and planning of maintenance of existing sensors in a wellbore is limited to a priori scheduling or esoteric assumptions.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a schematic diagram of a tubular string provided in a wellbore;

FIG. 2 is a schematic cross-sectional view of an example tubular string having a sensor nipple and corresponding port according to the disclosure herein;

FIG. 3 is a schematic cross-sectional view of another example of a tubular string having a sensor nipple coupled via an connector or fitting according to the disclosure herein;

FIG. 4 illustrates an example neural network, according to one aspect of the present disclosure;

FIG. 5 is an example method of predicting and classifying integrated sensor system responses, according to one aspect of the present disclosure; and

FIGS. 6A-B illustrate schematic diagram of example computing device and system according to one aspect of the present disclosure.

### DETAILED DESCRIPTION

Various example embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the example embodiments described herein. However, it will be understood by those of ordinary skill in the art that the example embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the example embodiments described herein.

A virtual sensor may be defined as a data driven component, whereby already existing and physical/in-situ formation and production sensors installed in a wellbore are leveraged to collect a set of properties such as pressure, temperature, flow volume, tc. The collected data is then leveraged and provided as input to a model that derives properties of interest in the wellbore including formation properties, in-situ fluids and their dynamics. By leveraging existing physical sensors and using the collected data to derive properties of interest mentioned, the need for dedicated physical sensors that directly measure the properties of interest is eliminated.

The present technology pertains to improvements in use of virtual sensors for determining formation and fluid properties as well as classifying the predicted as plausible or outlier responses that can indicate the need for maintenance of downhole physical sensors. The disclosed methods enable forecasting, in real-time, responses of virtual sensors and classify the forecasted response as an outlier or expected response, which can in turn predict the need for maintenance of the physical sensors.

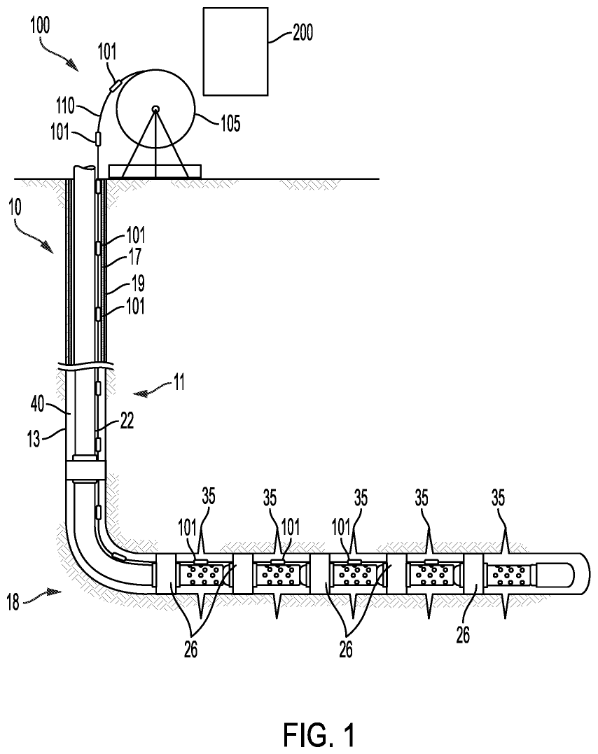

FIG. 1 is a schematic diagram depicting an environment in which the present disclosure may be implemented. As illustrated, the environment includes a producing wellsite 10. With respect to the example embodiment shown in FIG. 1, the producing wellsite 10 includes a tubular string 22 for use in completion and stimulation of formation, and an annulus 40. The terms stimulation and injection, as used herein, can include fracking, acidizing, hydraulic work, and other work-overs. The tubular string 22 may be made up of a number of individual tubulars, also referred to as sections or joints. The sections can include multiple such assemblies as well as blank tubing, perforated tubing, shrouds, joints, or any other sections as are known in the industry. Each of the tubulars of the tubular string 22 may have a central flow passage an internal fluid and an external surface. The term “tubular” may be defined as one or more types of connected tubulars as known in the art, and can include, but is not limited to, drill pipe, landing string, tubing, production tubing, jointed tubing, coiled tubing, casings, liners, or tools with a flow passage or other tubular structure, combinations thereof, or the like.

A wellbore 13 extends through various earth strata. Wellbore 13 has a substantially vertical section 11, the upper portion of which has installed therein casing 17 held in place by cement 19. Wellbore 13 also has a substantially deviated section 18, shown as substantially horizontal, extending through a hydrocarbon bearing portion of a subterranean formation 20. As illustrated, substantially horizontal section 18 of wellbore 13 is open hole, such that there is not a casing. It is understood that within the present disclosure, the wellbore may be cased or open, vertical, horizontal, or deviated, or any other orientation.

Packers 26 straddle target zones of the formation. The packers 26 can isolate the target zones for stimulation and production and which may have fractures 35. The packers 26 may be swellable packers. The packers 26 can also be other types of packers as are known in the industry, for example, slip-type, expandable or inflatable packers. Additional downhole tools or devices may also be included on the work string, such as valve assemblies, for example safety valves, inflow control devices, check valves, etc., as are known in the art. The tubing sections between the packers 26 may include sand screens to prevent the intake of particulate from the formation as hydrocarbons are withdrawn. Various suitable sand screens include wire mesh, wire wrap screens, perforated or slotted pipe, perforated shrouds, porous metal membranes, or other screens which permit the flow of desirable fluids such as hydrocarbons and filter out and prevent entry of undesirable particulates such as sand.

As shown, an array of sensors 100 can be spoolable from spool 105. The array of sensors 100 is shown as having a line 110 which connect each of the individual sensors 101. Plurality of sensors 101 are disposed along the longitudinal length of the tubular string 22 in the wellbore 13. Each sensor 101 is an in-situ physical sensor capable of collecting a set of properties (data/measurements) such as pressure, temperature, flow volume, etc. While illustrated as connected by line 110, the array of sensors 100 can also be coupled with the tubular string 22 without the line 110. Data from the array of sensors 101 may be transmitted along the line 110 and provided to one or more processors at the surface, such as device (processing unit/controller) 200 discussed further below, which can be a desktop/local processor in a laboratory associated with wellbore 13 or can be a cloud based processor that is remotely accessible for implementing virtual sensor functionalities, as will be described below. In other examples, data from the array of sensors 101 can be transmitted wirelessly or through the tubular string 22 to surface and/or device 200. Sensors 101 can be any one or more of a pressure sensor, a temperature sensor and/or rate sensor for measuring rate of fluid production in wellbore 13.

The line 110 may be a cord, line, metal, tubing encased conductor (TEC), fiber optic, or other material or construction, and may be conductive and permit power and data to transfer over the line 110 between each of the sensors 101 and to the surface. The line 110 may be sufficiently ductile to permit spooling and some amount of bending, but also sufficiently rigid to hold a particular shape in the absence of external force.

A producing wellsite can be divided into production zones through the use of one or more packers 26. The production flow comes from the formation and may pass through a screen, through a flow regulator (inflow control device (ICD), autonomous inflow control device (AICD), inflow control valve (ICV), choke, nozzle, baffle, restrictor, tube, valve, et cetera), and into the interior of the tubing.

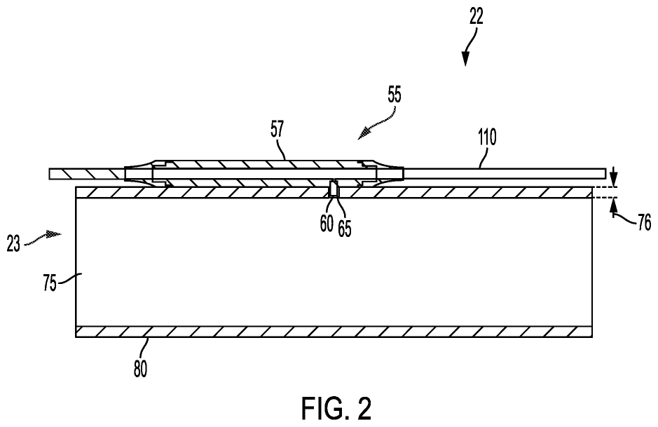

FIG. 2 is a cross-sectional view of a tubular 23 of a tubular string 22 according to the present disclosure. The tubular string 22 can be made from one or more tubulars 23 coupled together forming a length of tubular string. The tubular 23 and tubular string 22 can have a central flow passage 75 formed therethrough. The tubular 23 can be coupled with one or more sensors from the array of sensors 100. A sensor 55 can be one sensor coupled with the senor array 100 of FIG. 1. The sensor 55 can be coupled with a nipple 60 inserted and received into sensor port 65 of the tubular 23.

The sensor 55 may be coupled with the line 110 which connects to other sensors in an array of sensors, such as array of sensors 100, in which the other sensors may be one or more sensors 55, other sensors, or any combination thereof. As shown the tubular 23 has a central flow passage 75 for flow of a fluid (such as, hydrocarbons, etc.) and an external surface 80. In order to monitor fluid properties (such as, temperature and pressure, etc.) within the tubular string 22 a nipple 60 can be coupled to each tubing sensor 55 within the array. The sensor 55 may have a main body 57 and have the nipple 60 extending therefrom. The nipple 60 may be elastomeric, plastic or metal. The nipple 60 can be welded or otherwise coupled with the sensor 55 depending on the arrangement of the nipple 60 and the engagement between the nipple 60 and the tubular 23. In at least one example, the nipple 60 and the tubular 23 can be a metal-to-metal engagement. In particular, the nipple 60 engages the tubular 23 via a corresponding sensor port 65 of tubular 23. The nipple 60 may be an extension or projection and shaped for entry into or otherwise coupling with the sensor port 65.

The sensor port 65, which may be a hole, aperture, notch, groove, indentation, or similar, can be created at any location on the tubing string, such as any location on any particular tubular 23 within the tubular string 22. The sensor port 65 may be made within an approximate location of the sensor 55 or any position or location where the sensor 55 may be. The sensor port 65 may be created by any method available (e.g. drilling, piercing, burning, pierce with attached nipple, etc.). In at least one example, the sensor port 65 can be created on-the-fly, such that a workman on-site can simply form the sensor port 65 and couple the sensor therein by insertion of the nipple 60 into the sensor port 65. The nipple 60 can be self-tapping arrangement for simultaneous formation of the sensor port 65 and coupling of the nipple 60 with the tubular 23. In other examples, the sensor port 65 can be a threaded aperture allowing threaded engagement between the sensor 55 and the tubular 23.

The sensor port 65 can extend from the external surface 80 toward the central flow passage 75 through a wall thickness 76 of the tubular 23. The sensor port 65 can extend through the wall thickness 76 sufficient for the sensor 55 and nipple 60 to measure one or more fluid properties of the fluid within the central flow passage 75. The sensor port 65 can extend through the wall thickness 76 sufficient for the nipple 60 to be in fluidic contact with the central flow passage 75, thus allowing one or more fluid property measurements.

The nipple 60 on the sensor 55 may be positioned inside the sensor port 65 and sealed by an elastomer, metal-to-metal, adhesive seal, or other sealing mechanism. The nipple 60 itself may provide a sealing. In at least one instance, the nipple 60 can be formed from an elastomeric element providing a seal upon coupling the nipple 60 with the sensor port 65. The sealing mechanism provided by between the nipple 60 and the sensor port 65 can prevent annulus fluid from entering the sensor port 65 and/or prevent fluid from exiting the central flow passage 75 and entering the annulus depending on the arrangement of the sensor port 65. In instances where the sensor port 65 extends through the wall thickness 76 of the tubular 23, the sealing mechanism can prevent fluid flow between the central flow passage 75 and annulus. In instances where the sensor port 65 extends through only a portion of the wall thickness 76, the sealing mechanism prevents fluid flow from the annulus into the sensor port 65.

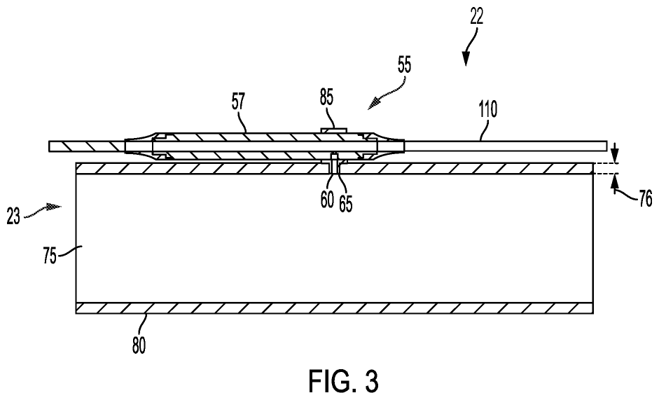

As illustrated in FIG. 3, a connector or fitting 85 may also be used for coupling the nipple 60 with the sensor port 65 of the tubular 23. In at least one instance, the connector or fitting 85 can be a clamp attached to securely hold the sensor 55, thereby reducing movement of the sensor 55 and nipple 60 relative to the tubular 23. The connector or fitting 85 can circumferentially extend around the tubular 23 to compress and/or secure the sensor 55 with the tubular 23. In some instances, alignment tolerances can be adjusted by including a full or semi-coil of the line 110 within the array providing slack and or reducing tension within line 110.

The array of sensors 100 disclosed herein can include sensors having the nipple, as disclosed in FIGS. 2-3, and conventional sensors without the nipple intermixed and coupled with the line 110. In at least one instance, the array of sensors 100 can alternate between sensors having a nipple and conventional sensors. In other instances, the array of sensors 100 can have a predetermined ratio of sensors having a nipple to conventional sensors. The ratio of sensors can be distributed in a pattern, such as two convention sensors followed by one sensor with a nipple, and repeated along the length of the line 110. The ratio of sensors can also be distributed substantially randomly along the length of the line 110. While a predetermined ratio of two to one is described above, it is within the scope of this disclosure to have any ratio including, but not limited to, one to one, three to one, three to two, or any other combination, and the ratio can be defined as either conventional sensors to nipple sensors or nipple sensors to conventional sensors. Accordingly, the array of sensors 100 of FIG. 1 may include a plurality of sensors as described according to FIGS. 2-3, as well as conventional sensors without a shroud and snorkel line, and may be arranged to alternate between the one and the other, any other combination or order along the line 110.

Moreover, although the sensors in FIGS. 1-3 are illustrated as coupled with a line (such as a TEC), the array of sensors may instead be simply coupled to the tubular or a collar without an intervening line between the sensors of the array.

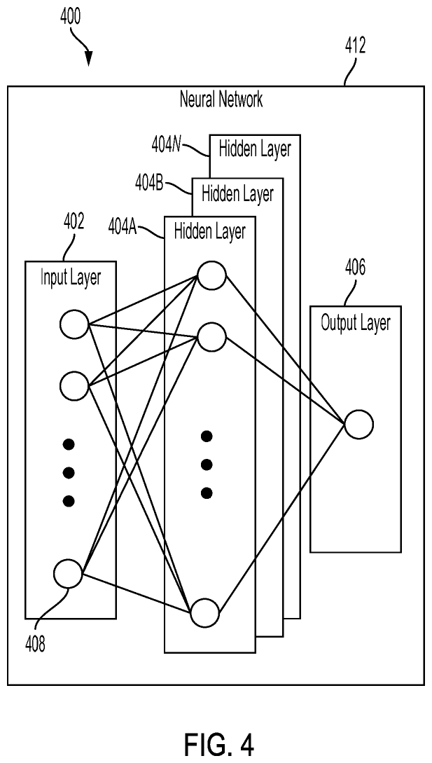

As mentioned above, a virtual sensor may be defined as a data driven component, whereby already existing and physical/in-situ formation and production sensors installed in a wellbore are leveraged to collect a set of properties such as pressure, temperature, flow volume, pressure, composition, fluid properties, etc. The collected data is then leveraged and provided as input to a model that derives properties of interest in the wellbore including formation properties, in-situ fluids and their dynamics. With physical sensors described with reference to FIGS. 1-3 serving as the physical/in-situ sensors of such virtual sensors, next an example neural network will be described with reference to FIG. 4, which can be used to receive data collected by sensors 101 to provide output of a virtual sensor.

FIG. 4 illustrates an example neural network, according to one aspect of the present disclosure. Example neural network 400 can be used as the cloud neural network and/or the desktop neural network. In one example, different neural network models can be used for cloud neural network or desktop neural network.

In FIG. 4, neural network 412 includes an input layer 402 which includes input data including, but not limited to, measurements from physical sensors 101, information about fluid injections in wellbore 13, structural mechanical changes to sub-surface rocks as a result of hydraulic induced changes such as changes to rocks due to injection of water, changes or new injections of fluids and material such as water an polymer into wellbore 13, etc.

Neural network 412 can include hidden layers 404A through 404N (collectively “404” hereinafter). Hidden layers 404 can include n number of hidden layers, where n is an integer greater than or equal to one. The number of hidden layers can be made to include as many layers as needed for the given application. Neural network 412 further includes an output layer 406 that provides an output resulting from the processing performed by hidden layers 304. Output can be a prediction of measurements of physical sensors such as sensors 101, which will be further described below.

Neural network 412 can be a multi-layer deep learning network of interconnected nodes. Each node can represent a piece of information. Information associated with the nodes is shared among the different layers and each layer retains information as information is processed. In some cases, neural network 412 can include a feed-forward network, in which case there are no feedback connections where outputs of the network are fed back into itself. In some cases, the neural network 412 can include a recurrent neural network, which can have loops that allow historical information to be carried across nodes while reading in input.

Information can be exchanged between nodes through node-to-node interconnections between the various layers. Nodes of input layer 402 can activate a set of nodes in first hidden layer 404A. For example, as shown, each of input nodes of input layer 402 is connected to each of the nodes of the first hidden layer 404A. Nodes of hidden layer 404A can transform the information of each input node by applying activation functions to the information. The information derived from the transformation can then be passed to and can activate nodes of next hidden layer (e.g., 404B), which can perform their own designated functions. Example functions include convolutional, up-sampling, data transformation, pooling, and/or any other suitable functions. Output of the hidden layer (e.g., 404B) can then activate nodes of next hidden layer (e.g., 404N), and so on. Output of the last hidden layer can activate one or more nodes of output layer 406, at which point an output is provided. In some cases, while nodes (e.g., node 408) in neural network 412 are shown as having multiple output lines, a node has a single output and all lines shown as being output from a node represent the same output value.

In some cases, each node or interconnection between nodes can have a weight that is a set of parameters derived from the training of neural network 412. For example, an interconnection between nodes can represent a piece of information learned about the interconnected nodes. The interconnection can have a numeric weight that can be tuned (e.g., based on a training dataset), allowing neural network 412 to be adaptive to inputs and able to learn as more data is processed.

Neural network 412 can be pre-trained to process the features from the data in input layer 402 using different hidden layers 404 in order to provide the output through output layer 406. In an example in which neural network 412 is used to predict/estimate output of sensors 101, neural network 412 can be trained using training data including, but not limited to, measurements from physical sensors 101, information about fluid injections in wellbore 13, structural mechanical changes to sub-surface rocks as a result of hydraulic induced changes such as changes to rocks due to injection of water, changes or new injections of fluids and material such as water an polymer into wellbore 13, etc.

In some cases, neural network 412 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until neural network 412 is trained enough so that the weights of the layers are accurately tuned.

For a first training iteration for neural network 412, the output can include values that do not give preference to any particular class due to the weights being randomly selected at initialization. A loss function can be used to analyze errors in the output. Any suitable loss function definition can be used.

The loss (or error) can be high for the first training since the actual values will be different than the predicted output. The goal of training is to minimize the amount of loss so that the predicted output is the same as the training label. Neural network 412 can perform a backward pass by determining which inputs (weights) most contributed to the loss of the network, and can adjust the weights so that the loss decreases and is eventually minimized.

A derivative of the loss with respect to the weights can be computed to determine the weights that contributed most to the loss of the network. After the derivative is computed, a weight update can be performed by updating the weights of the filters. For example, weights can be updated so that they change in the opposite direction of the gradient. A learning rate can be set to any suitable value, with a high learning rate including larger weight updates and a lower value indicating smaller weight updates.

Neural network 412 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 112 can represent any other deep network other than a CNN, such as an autoencoder, a deep belief nets (DBNs), a Recurrent Neural Networks (RNNs), etc.

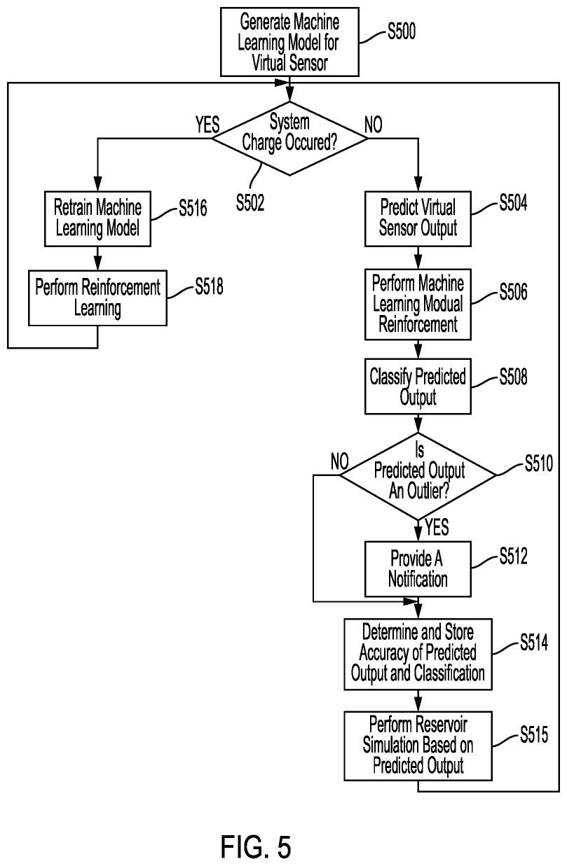

With examples of components of virtual sensors (both physical sensors and machine learning component) described above, examples will now be described with reference to FIG. 5 for predicting output of virtual sensors (determining formation and fluid properties) as well as classifying the predicted as plausible or outlier responses that can indicate the need for maintenance of downhole physical sensors.

FIG. 5 is an example method of predicting and classifying integrated sensor system responses, according to one aspect of the present disclosure. FIG. 5 will be described from perspective of device 200 (controller) of FIG. 1, which can be a processing component. However, it will be understood that device 200 has one or more associated processors configured to execute computer-readable instructions to perform functions described below with reference to FIG. 5.

At S500, device 200 generates a machine learning model for a given virtual sensor. A single virtual sensor may take data collected by several physical sensors to provide the intended output or may be associated with a single physical sensor.

In one example embodiment, a single neural network such as that described above with reference to FIG. 4, may take as input distinct pieces of information to train the neural network and generate the machine learning model. The distinct pieces of information may be referred to as geomechanics information, physical sensor information and injector well information.

Geomechanics information may include but is not limited to information indicative structural mechanics of the sub-surface rock formations (e.g., sanding) as a result of hydraulic induced changes such as injection of water, polymer and/or any other type of known or to be developed fluid/material for effective and efficient extraction of hydrocarbons from a wellbore such as wellbore 13 of FIG. 1.

Physical sensor information may include actual measurements of a set of properties by one or more of physical sensors 101 including, but not limited to, pressure, temperature, flow volume, flow rate, etc. Physical sensor information can further include expected shelf life information and duration of operation of each sensor since initial installment and activation.

Injector well information may include, but is not limited to, information on fluids and materials being injected in wellbore 13 for production.

In one example, various samples may be extracted using known or to be developed tools such as those described above with reference to FIG. 1, from wellbore 13. These samples are then taken to a laboratory to be analyzed to determine various formation and rock-fluid interaction properties of rocks and soil samples. Various apparatuses and methods exist for testing an analyzing the core samples. One example apparatus is a centrifuge with a rotating arm to an end of which a sample holder and a vial is connected to determine fluid-rock interaction.

As these samples are extracted from wellbore 13, sensors 101 continuously collect pressure, temperature and/or flow rate data from wellbore 13. Accordingly, once such rock-fluid interaction properties are determined in a laboratory setting (using physical and digital experiments described above at laboratory and/or in-situ conditions), the derived rock-fluid interaction properties such as absolute, effective and relative permeability may be associated with recorded pressure, temperature and/or flow rate records of sensors 101.

Furthermore, historical data on various types of geomechanics, core analysis and inter-well hydraulic communication information and their effect on various sub-surface formations and rock-fluid interaction properties may be used in training the machine learning model in addition to other user defined numerical models of the subsurface.

Therefore, a machine learning model using various known or to be developed deep neural networks (DNNs) can be constructed to correlate recorded pressure, temperature and/or flow rate recordings with rock-fluid interaction properties such as absolute, effective and relative permeability.

In one example, a single model can be made for correlating all or some of the recorded variables to one or more rock-fluid interaction properties (e.g., pressure/temperature v. permeability, pressure/temperature/rate v. permeability, etc.). In another example, a separate machine learning model can be constructed to correlate each recorded variable (pressure, temperature or rate) to such rock-fluid interaction properties (e.g., pressure v. permeability, temperature v. permeability, rate v. v. permeability, etc.).

As noted, the above distinct pieces of information may be inputted into a neural network for training and generating the machine learning model. Alternatively, each piece of information specified above, may be inputted into a separated neural network for training the same. In such instance, the generated machine learning model may include three separate models.

After training and generation of a machine learning model at S500, at S502, device 200 determines if a system change has occurred (e.g., at a first time instance, t₀). A system change can be any one of installment of a new physical sensor, injection of fluid or material into wellbore 13 and/or any other change to a system of operation wellbore 13.

If at S502 device 200 determines that a system change has not occurred, then at S504, using the generated machine learning model, device 200 predicts/estimates a current and/or a future output of the virtual sensor. The predicted output of the virtual sensor can be for example, predicted downhole formation and fluid properties, relative permeability, effective permeability, changes in chemical and physical properties of sub-surface rocks such as porosity, etc.

At S506, device 200 uses the predicted output for reinforcement of machine learning model generated at S500.

At S508, device 200 classifies the predicted output, where such classification can include determining whether the predicted output is an outlier relative to average or expected output of the virtual sensor by inputting the predicted output into the machine learning model.

At S510, device 200 determines whether the classification indicates that the predicted output is an outlier. If not, the process proceeds to S514, which will be described below.

However, if at S510, device 200 determines that the classification indicates that the predicted output is an outliner, then at S512, device 200 provides (generates and sends) a notification that can be displayed on a terminal accessible by an operator. Such notification may direct the operator to evaluate the virtual sensor and/or the underlying physical sensor for possible malfunctioning, repair, recalibration and maintenance, thus allowing a preemptive approach in optimizing operation of virtual sensors in wellbore operations.

At S514, device 200 may determine accuracy of the predicted output and the classification and store the same for use in retraining the machine learning model upon detecting a system change, as will be described below. In one example, the predicted output includes replication of previously captured events in addition to forecasted outcome. As a result, prediction accuracy of the machine learning model is assessed based on its ability to properly predict events that have already taken place or can take place in the future. Subsequent accuracy assessments will occur as new data is captured by the physical sensor.

At S515, device 200 may use the predicted output to perform or update reservoir simulation models, which can be performed by device 200 and/or any other processing unit(s) configured for such simulation. Reservoir simulation can be performed according to any known or to be developed method of reservoir simulation taking the predicted output as one input or means of updating existing parameters of the reservoir simulation model.

Thereafter, the process may revert back to S502, where device 200 may repeat S502 to S518 periodically. In one example, the periodicity with which the method of FIG. 5 is repeated is a configurable parameter that may be determined based on experiments and/or empirical studies.

Referring back to S502, if device 200 detects a system change as described above, then at S516, device 200 retrains the machine learning model of S500 based on the detected system change and the stored accuracy of prior prediction and classification per S514 described above. In one example, a system change can be an increase or decrease in the rate of production, temperature, pressure. These events can be associated with changes due to production operations or production induced (response of the formation due to production. For example, response to a new injector or producer well added or removed).

At S518, device 200 performs a reinforcement learning to correct the predicted outputs of the machine learning model using various types of inputs such as manual reinforcement by a system operator, historical data corresponding to previously determined outputs given similar system changes, related and corresponding data from nearby wellbores having experienced or undergone similar system changes (e.g., similar rock formation due to induced hydraulic changes, new sensor installments, similar fluid/material injections, etc.).

Thereafter, the process reverts back to S502 and S502 to S518 may be repeated periodically. In one example, the periodicity with which the method of FIG. 5 is repeated is a configurable parameter that may be determined based on experiments and/or empirical studies.

Example embodiments described above provide numerous improvements of physical sensors installed within wellbores to estimate updates in rock-fluid interaction properties such as relative permeability and capillary pressure using mathematical models and DNNs and data collected by such physical sensors (e.g., pressure, temperature, rate of fluid production, etc.). This eliminates the need for installing specialized hardware and additional physical sensors inside wellbores for purposes of determining and estimating changes in such rock-fluid interaction properties. Furthermore, example embodiments described above can be utilized for predictive output determination maintenance and troubleshooting of existing physical sensors related to such sensors' completion, piping, tubing, casing, etc. These advantages help reduce costs associated with evaluating formation properties during production and updating reservoir simulation models with concurrent information regarding the description of rock-fluid interaction in the formation.

The disclosure now turns to various components and system architectures that can be utilized as device 200 to implement the functionalities described above.

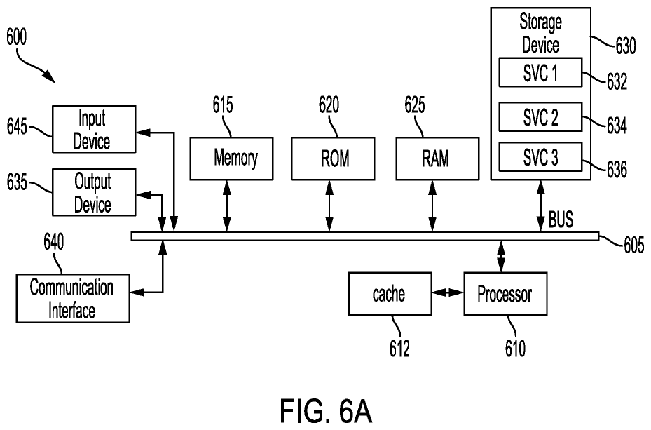

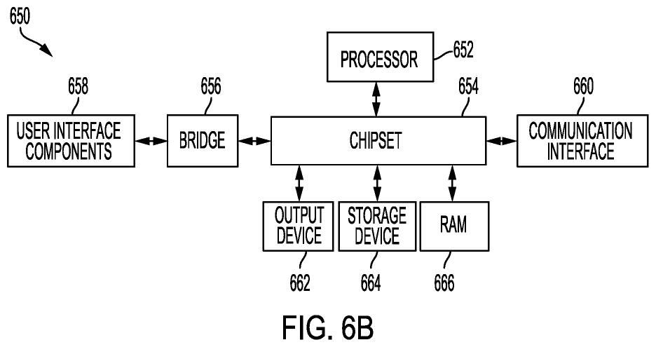

FIGS. 6A-B illustrates schematic diagram of example computing device and system according to one aspect of the present disclosure. FIG. 6A illustrates a computing device which can be employed to perform various steps, methods, and techniques disclosed above. The more appropriate embodiment will be apparent to those of ordinary skill in the art when practicing the present technology. Persons of ordinary skill in the art will also readily appreciate that other system embodiments are possible.

Example system and/or computing device 600 includes a processing unit (CPU or processor) 610 and a system bus 605 that couples various system components including the system memory 615 such as read only memory (ROM) 620 and random access memory (RAM) 625 to the processor 610. The processors disclosed herein can all be forms of this processor 610. The system 600 can include a cache 612 of high-speed memory connected directly with, in close proximity to, or integrated as part of the processor 610. The system 600 copies data from the memory 615 and/or the storage device 630 to the cache 612 for quick access by the processor 510. In this way, the cache provides a performance boost that avoids processor 610 delays while waiting for data. These and other modules can control or be configured to control the processor 610 to perform various operations or actions. Other system memory 615 may be available for use as well. The memory 615 can include multiple different types of memory with different performance characteristics. It can be appreciated that the disclosure may operate on a computing device 600 with more than one processor 610 or on a group or cluster of computing devices networked together to provide greater processing capability. The processor 610 can include any general purpose processor and a hardware module or software module (service), such as service (SVC) 1 632, SVC 2 634, and SVC 3 636 stored in storage device 630, configured to control the processor 610 as well as a special-purpose processor where software instructions are incorporated into the processor. The processor 610 may be a self-contained computing system, containing multiple cores or processors, a bus, memory controller, cache, etc. A multi-core processor may be symmetric or asymmetric. The processor 610 can include multiple processors, such as a system having multiple, physically separate processors in different sockets, or a system having multiple processor cores on a single physical chip. Similarly, the processor 610 can include multiple distributed processors located in multiple separate computing devices, but working together such as via a communications network. Multiple processors or processor cores can share resources such as memory 615 or the cache 612, or can operate using independent resources. The processor 610 can include one or more of a state machine, an application specific integrated circuit (ASIC), or a programmable gate array (PGA) including a field PGA (FPGA).

The system bus 605 may be any of several types of bus structures including a memory bus or memory controller, a peripheral bus, and a local bus using any of a variety of bus architectures. A basic input/output (BIOS) stored in ROM 620 or the like, may provide the basic routine that helps to transfer information between elements within the computing device 600, such as during start-up. The computing device 600 further includes storage devices 630 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 630 can include software modules/services 632, 634, 636 for controlling the processor 610. The system 600 can include other hardware or software modules. The storage device 630 is connected to the system bus 605 by a drive interface. The drives and the associated computer-readable storage devices provide nonvolatile storage of computer-readable instructions, data structures, program modules and other data for the computing device 600. In one aspect, a hardware module that performs a particular function includes the software component stored in a tangible computer-readable storage device in connection with the necessary hardware components, such as the processor 610, bus 605, and so forth, to carry out a particular function. In another aspect, the system can use a processor and computer-readable storage device to store instructions which, when executed by the processor, cause the processor to perform operations, a method or other specific actions. The basic components and appropriate variations can be modified depending on the type of device, such as whether the device 600 is a small, handheld computing device, a desktop computer, or a computer server. When the processor 610 executes instructions to perform “operations”, the processor 610 can perform the operations directly and/or facilitate, direct, or cooperate with another device or component to perform the operations.

Although the exemplary embodiment(s) described herein employs the hard disk 630, other types of computer-readable storage devices which can store data that are accessible by a computer, such as magnetic cassettes, flash memory cards, digital versatile disks (DVDs), cartridges, random access memories (RAMs) 625, read only memory (ROM) 620, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 600, an input device 645 represents any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems enable a user to provide multiple types of input to communicate with the computing device 600. The communications interface 640 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 610. The functions these blocks represent may be provided through the use of either shared or dedicated hardware, including, but not limited to, hardware capable of executing software and hardware, such as a processor 610, that is purpose-built to operate as an equivalent to software executing on a general purpose processor. For example the functions of one or more processors presented in FIG. 6A may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 620 for storing software performing the operations described below, and random access memory (RAM) 625 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 600 shown in FIG. 6A can practice all or part of the recited methods, can be a part of the recited systems, and/or can operate according to instructions in the recited tangible computer-readable storage devices. Such logical operations can be implemented as modules configured to control the processor 610 to perform particular functions according to the programming of the module. For example, FIG. 6A illustrates three modules/services SVC 632, SVC 634 and SVC 636 which are modules configured to control the processor 610. These modules may be stored on the storage device 630 and loaded into RAM 625 or memory 615 at runtime or may be stored in other computer-readable memory locations.

One or more parts of the example computing device 600, up to and including the entire computing device 600, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 610 can include all types of processors disclosed herein, including a virtual processor. However, when referring to a virtual processor, the processor 610 includes the software components associated with executing the virtual processor in a virtualization layer and underlying hardware necessary to execute the virtualization layer. The system 600 can include a physical or virtual processor 610 that receive instructions stored in a computer-readable storage device, which cause the processor 610 to perform certain operations. When referring to a virtual processor 610, the system also includes the underlying physical hardware executing the virtual processor 610.

FIG. 6B illustrates an example computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 652, representative of any number of physically and/or logically distinct resources capable of executing software, firmware, and hardware configured to perform identified computations. Processor 652 can communicate with a chipset 654 that can control input to and output from processor 652. In this example, chipset 654 outputs information to output device 662, such as a display, and can read and write information to storage device 664, which can include magnetic media, and solid state media, for example. Chipset 654 can also read data from and write data to RAM 666. A bridge 656 for interfacing with a variety of user interface components 685 can be provided for interfacing with chipset 654. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 654 can also interface with one or more communication interfaces 660 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 652 analyzing data stored in storage 664 or 666. Further, the machine can receive inputs from a user via user interface components 685 and execute appropriate functions, such as browsing functions by interpreting these inputs using processor 652.

It can be appreciated that example systems 600 and 650 can have more than one processor 610/652 or be part of a group or cluster of computing devices networked together to provide greater processing capability.

Embodiments within the scope of the present disclosure may also include tangible and/or non-transitory computer-readable storage devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. Rather, the described features and steps are disclosed as possible components of systems and methods within the scope of the appended claims.

### STATEMENTS OF THE DISCLOSURE INCLUDE

Statement 1: A method includes detecting a change to a system of operating a wellbore to yield a determination, the system including a virtual sensor, the virtual sensor including a physical sensor placed in the wellbore for collecting one or more physical properties inside the wellbore; and based on the determination, performing one of retraining a machine learning model for predicting an output of the virtual sensor or predicting an output of the virtual sensor using the machine learning mode, the predicted output being indicative of at least one of sub-surface formation or fluid properties inside the wellbore.

Statement 2: The method of statement 1, wherein the change is one or more of an injection of a fluid or material into the wellbore and formation or a physical change to a system for operating the wellbore.

Statement 3: The method of statement 1, further including generating the machine learning model for predicting the output of the virtual sensor using: information associated with structural mechanics of sub-surface rocks in the wellbore resulting from hydraulic induced changes; information associated with injection of fluids inside the wellbore and changes to flow to and from the wellbore; and physical parameters of and prior measurements by the physical sensor.

Statement 4: The method of statement 3, wherein the prior measurements include temperature and pressure measurements in the wellbore.

Statement 5: The method of statement 1, wherein if the determination indicates that the change to the virtual sensor has occurred, the method includes retraining the machine learning mode based on the change.

Statement 6: The method of statement 5, further including performing reinforcement learning of the machine learning model based on inputs from a system operator, historical data and data from at least one neighboring wellbore.

Statement 7: The method of statement 2, wherein if the determination indicates no change to the virtual sensor, the method includes: predicting the output of the virtual sensor; and determining if the predicted output constitutes an outlier or is indicative of a sub-surface change within the wellbore.

Statement 8: The method of statement 7, wherein upon determining that the predicted output constitutes an outliner, the method further includes generating a notification for evaluating the physical sensor.

Statement 9: The method of statement 7, further including determining an accuracy the prediction.

Statement 10: The method of statement 9, wherein if the accuracy does not meet a threshold, the accuracy is stored for use in retraining the machine learning model upon detection of a subsequent change to the system.

Statement 11: The method of statement 1, wherein determining the change to the system is performed periodically.

Statement 12: The method of statement 1, further comprising: generating a reservoir simulation model using the predicted output.

Statement 13: A controller includes memory having computer-readable instructions stored therein; and one or more processors configured to execute the computer-readable instructions to detect a change to a system of operating a wellbore to yield a determination, the system including a virtual sensor, the virtual sensor including a physical sensor placed in the wellbore for collecting one or more physical properties inside the wellbore; and based on the determination, perform one of retraining a machine learning model for predicting an output of the virtual sensor or predicting an output of the virtual sensor using the machine learning mode, the predicted output being indicative of at least one of sub-surface formation or fluid properties inside the wellbore.

Statement 14: The controller of statement 13, wherein the change is one or more of an injection of a fluid or material into the wellbore and formation or a physical change to a system for operating the wellbore.

Statement 15: The controller of statement 13, wherein the one or more processors are configured to execute the computer-readable instructions to generate the machine learning model for predicting the output of the virtual sensor using: information associated with structural mechanics of sub-surface rocks in the wellbore resulting from hydraulic induced changes; information associated with injection of fluids inside the wellbore and changes to flow to and from the wellbore; and physical parameters of and prior measurements by the physical sensor.

Statement 16: The controller of statement 15, wherein the prior measurements include temperature and pressure measurements in the wellbore.

Statement 17: The controller of statement 13, wherein if the determination indicates that the change to the virtual sensor has occurred, the one or more processors are configured to execute the computer-readable instructions to retrain the machine learning mode based on the change.

Statement 18: The controller of statement 17, wherein the one or more processors are configured to execute the computer-readable instructions to perform reinforcement learning of the machine learning model based on inputs from a system operator, historical data and data from at least one neighboring wellbore.

Statement 19: The controller of statement 14, wherein if the determination indicates no change to the virtual sensor, the one or more processors are configured to execute the computer-readable instructions to predict the output of the virtual sensor; and determine if the predicted output constitutes an outlier or is indicative of a sub-surface change within the wellbore.

Statement 20: The controller of statement 19, wherein upon determining that the predicted output constitutes an outliner, the one or more processors are configured to execute the computer-readable instructions to generate a notification for evaluating the physical sensor.

Statement 21: The controller of statement 19, wherein the one or more processors are configured to execute the computer-readable instructions to determine an accuracy the prediction.

Statement 22: The controller of statement 21, wherein if the accuracy does not meet a threshold, the accuracy is stored for use in retraining the machine learning model upon detection of a subsequent change to the system.

Statement 23: The controller of statement 13, wherein determining the change to the system is performed periodically.

Statement 24: The controller of statement 13, wherein the one or more processors are configured to execute the computer-readable instructions to generate a reservoir simulation model using the predicted output.

1. A method comprising:
detecting a change to a system of operating a wellbore to yield a determination, the system including a virtual sensor, the virtual sensor including a physical sensor placed in the wellbore for collecting one or more physical properties inside the wellbore; and
based on the determination, performing one of retraining a machine learning model for predicting an output of the virtual sensor or predicting an output of the virtual sensor using the machine learning model, the predicted output being indicative of at least one of sub-surface formation or fluid properties inside the wellbore.

2. The method of claim 1, wherein the change is one or more of an injection of a fluid or material into the wellbore or a physical change to a system for operating the wellbore.

3. The method of claim 1, further comprising:
generating the machine learning model for predicting the output of the virtual sensor using:
information associated with structural mechanics of sub-surface rocks in the wellbore resulting from hydraulic induced changes;
information associated with injection of fluids inside the wellbore and changes to flow to and from the wellbore; and
physical parameters of and prior measurements by the physical sensor.

4. The method of claim 3, wherein the prior measurements include temperature and pressure measurements in the wellbore.

5. The method of claim 1, wherein if the determination indicates that the change to the virtual sensor has occurred, the method includes retraining the machine learning model based on the change.

6. The method of claim 5, further comprising:
performing reinforcement learning of the machine learning model based on inputs from a system operator, historical data and data from at least one neighboring wellbore.

7. The method of claim 2, wherein if the determination indicates no change to the virtual sensor, the method includes:
predicting the output of the virtual sensor; and
determining if the predicted output constitutes an outlier or is indicative of a sub-surface change within the wellbore.

8. The method of claim 7, wherein upon determining that the predicted output constitutes an outlier, the method further comprises:
generating a notification for evaluating the physical sensor.

9. The method of claim 7, further comprising:
determining an accuracy the prediction.

10. The method of claim 9, wherein if the accuracy does not meet a threshold, the accuracy is stored for use in retraining the machine learning model upon detection of a subsequent change to the system.

11. The method of claim 1, wherein determining the change to the system is performed periodically.

12. The method of claim 1, further comprising: generating a reservoir simulation model using the predicted output.

13. A controller comprising:
memory having computer-readable instructions stored therein; and
one or more processors configured to execute the computer-readable instructions to:
detect a change to a system of operating a wellbore to yield a determination, the system including a virtual sensor, the virtual sensor including a physical sensor placed in the wellbore for collecting one or more physical properties inside the wellbore; and
based on the determination, perform one of retraining a machine learning model for predicting an output of the virtual sensor or predicting an output of the virtual sensor using the machine learning model, the predicted output being indicative of at least one of sub-surface formation or fluid properties inside the wellbore.

14. The controller of claim 13, wherein the change is one or more of an injection of a fluid or material into the wellbore or a physical change to a system for operating the wellbore.

15. The controller of claim 13, wherein the one or more processors are configured to execute the computer-readable instructions to generate the machine learning model for predicting the output of the virtual sensor using:
information associated with structural mechanics of sub-surface rocks in the wellbore resulting from hydraulic induced changes;
information associated with injection of fluids inside the wellbore and changes to flow to and from the wellbore; and
physical parameters of and prior measurements by the physical sensor.

16. The controller of claim 15, wherein the prior measurements include temperature and pressure measurements in the wellbore.

17. The controller of claim 13, wherein if the determination indicates that the change to the virtual sensor has occurred, the one or more processors are configured to execute the computer-readable instructions to retrain the machine learning model based on the change.

18. The controller of claim 17, wherein the one or more processors are configured to execute the computer-readable instructions to perform reinforcement learning of the machine learning model based on inputs from a system operator, historical data and data from at least one neighboring wellbore.

19. The controller of claim 14, wherein if the determination indicates no change to the virtual sensor, the one or more processors are configured to execute the computer-readable instructions to:
predict the output of the virtual sensor; and
determine if the predicted output constitutes an outlier or is indicative of a sub-surface change within the wellbore.

20. The controller of claim 19, wherein upon determining that the predicted output constitutes an outliner, the one or more processors are configured to execute the computer-readable instructions to generate a notification for evaluating the physical sensor.

21-24. (canceled)
